(19) United States
(12) Patent Application Publication
(10) Pub. No.: US 2011/0284194 A1
(43) Pub. Date: Nov. 24, 2011

(54) Elastomeric Gasket

(76) Inventors: Asish Sarkar, Zebulon, NC (US); Jonathan Shaw, Goldsboro, NC (US)

(21) Appl. No.: 12/784,068

(22) Filed: May 20, 2010

(51) Int. Cl. F28F 3/08; B05D 3/02; B05D 3/10

(52) U.S. Cl. 165/167; 427/299; 427/314

(57) ABSTRACT

A plate heat exchanger includes a set of plates and gaskets. Each one of the set gaskets is disposed between two adjacent plates of the set of plates. A gasket of the set of gaskets includes a base material, a fluorocarbon coating disposed on the base material; and an interface layer disposed between the base material and the fluorocarbon coating. The interface layer includes a material gradient transitioning from the base material to the fluorocarbon coating. The fluorocarbon coating is chemically bound to the base material.

### FIELD OF THE INVENTION

The present invention relates generally to a gasket. More particularly, the present invention relates to a treated gasket for use in a plate heat exchanger.

### BACKGROUND OF THE INVENTION

It is generally known that plate heat exchangers offer efficient transfer of heat from one fluid to another in a relatively small volume. Typically, plate heat exchangers include several plates to one hundred or more of plates which are stacked together and sealed together. Relatively small plate heat exchangers are often permanently sealed together via brazing, for example. Larger plate heat exchangers are more typically sealed via gaskets disposed between the plates or between pairs of plates. Because the gasket is disposed about the perimeter of each plate and because of the number of plates, plate heat exchangers often have between 100 meters (m) to 5 kilometers (km) total length of gasket material. In general, leakage is not acceptable. Accordingly, gaskets for plate heat exchangers must be reliable and fabricated with a high degree of precision.

Plate heat exchangers are configured to tolerate a wide variety of fluids and may be utilized in several different application. Examples of fluids utilized in plate heat exchangers include water, ammonia, vegetable oil, crude oil and various distillates thereof, strong acids and bases, and/or the like. Examples of particular applications for plate heat exchangers include condensation of high temperature/pressure steam, evaporation of halocarbons in the presence of hydrocarbon lubricants, cooling sulfuric acid, heating sodium hydroxide solutions, and the like.

In general, an advantageous material characteristic for gasket material includes a high degree of elasticity (e.g., greater than 100%) to conform to any irregularity and form a seal. However, due to the relatively high pressures plate heat exchangers may be exposed to (e.g., 0.1 kilogram per square centimeter (kg/cm²) to 10 kg/cm² or more), the gasket material can not be too soft nor is it advantageous for the gasket to become overly soft in response to heat, exposure to the fluids within the plate heat exchanger, and/or exposure to environmental agents such as oxygen, ozone, sunlight, and the like. Unfortunately, materials that are resistant to chemical degradation and sufficiently elastic to form adequate seals are typically very expensive.

Accordingly, it is desirable to provide a less costly gasket material for plate heat exchangers that is able to overcome the foregoing disadvantages at least to some extent.

### SUMMARY OF THE INVENTION

The foregoing needs are met, to a great extent, by the present invention, where in some embodiments a less costly gasket material for plate heat exchangers that is able to overcome the foregoing disadvantages at least to some extent is provided.

An embodiment of the present invention pertains to a plate heat exchanger. The plate heat exchanger includes a set of plates and gaskets. Each one of the set gaskets is disposed between two adjacent plates of the set of plates. A gasket of the set of gaskets includes a base material, a fluorocarbon coating disposed on the base material; and an interface layer disposed between the base material and the fluorocarbon coating. The interface layer includes a material gradient transitioning from the base material to the fluorocarbon coating. The fluorocarbon coating is chemically bound to the base material.

Another embodiment of the present invention relates to a method of manufacturing a gasket for a plate heat exchanger. In this method, a gasket core is cleaned, heated, and coated. The gasket core includes a base material. The coating includes a liquid mixture which includes hydrocarbons. This liquid hydrocarbon mixture permeates an outer surface of the gasket core and generates an interface layer disposed between the base material and the liquid hydrocarbon mixture. The interface layer includes a material gradient transitioning from the base material to the liquid hydrocarbon mixture. The liquid hydrocarbon mixture is cured into an elastomeric coating that is chemically bound to the base material.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded view of a simplified plate heat exchanger suitable for use with a gasket according to an embodiment of the invention.

FIG. 2 is a side view of a plate heat exchanger suitable for use with a gasket according to an embodiment of the invention.

FIG. 3 is a cross-sectional view of the gasket disposed between two heat exchange plates in accordance with the embodiment of FIG. 1.

FIG. 3 is a magnified view of an outer portion of the gasket in accordance with the embodiment of FIG. 1

### DETAILED DESCRIPTION

The invention will now be described with reference to the drawing figures, in which like reference numerals refer to like parts throughout. An embodiment in accordance with the present invention provides an improved gasket that is resistant to degradation caused by exposure to chemicals, temperature extremes, ultraviolet light, and the like. This improved gasket is further capable of providing excellent sealing characteristics and is highly resistant to material fatigue. In addition, the material and labor related costs associated with manufacturing this improved gasket are much reduced in comparison to conventional gaskets. In short, embodiments of the inventive gasket perform at least as well if not better than conventional gaskets and are relatively less expensive than conventional gaskets.

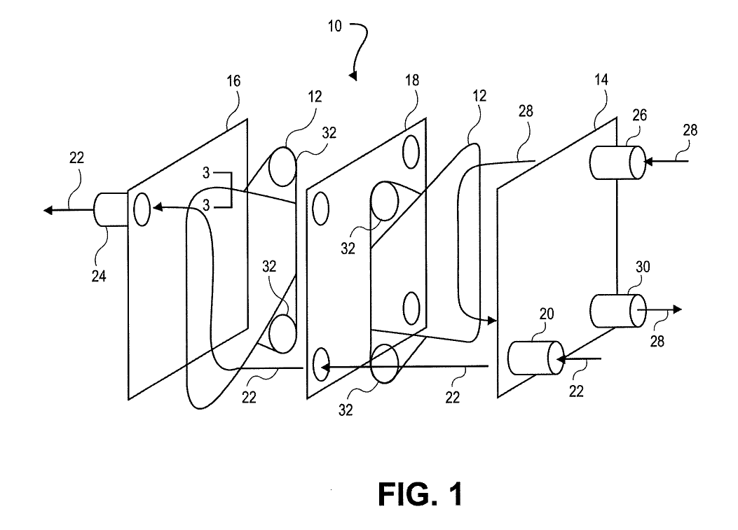

Another embodiment of the invention provides a plate heat exchanger suitable for use with the improved gasket. Referring now to FIG. 1, an exploded view of a plate heat exchanger, generally designated 10, is illustrated. As shown in FIG. 1, the plate heat exchanger 10 includes a plurality of gaskets 12 disposed between various plates of the plate heat exchanger 10. In the example shown, the plate heat exchanger 10 includes a follower 14 and a head 16 and a heat exchange plate 18. When assembled, a first fluid may be introduced to the plate heat exchanger 10 via a first inlet 20. As a result of the arrangement of the heat exchange plate 18 and gaskets 12, the first fluid is configured to traverse a first flow path 22 and exit the plate heat exchanger 10 via a first outlet 24. In addition, a second fluid may be introduced to the plate heat exchanger 10 via a second inlet 26. As a result of the arrangement of the heat exchange plate 18 and gaskets 12, the second fluid is configured to traverse a second flow path 28 and exit the plate heat exchanger 10 via a second outlet 30. As is generally known, the heat exchange plate 18 may include metal or other such thermally conductive material. Due to the relatively high surface area available for thermal exchange, the efficiency of the plate heat exchanger 10 may exceed 90%.

However, it is generally important to reduce or eliminate any intermixing of the two fluids. For example, the first fluid may be a food product such as milk and the second fluid may include glycol or other anti-freeze agent and/or an anti-scaling agent which is not approved for human consumption. If any mixing of the two fluids were to occur, a significant loss of product, or worse, may result. As the gaskets 12 present the greatest potential for leakage, the gaskets 12 may include several features to reduce the risk. For example, the gaskets 12 may include a gasket 32 within the gasket 12 type structure.

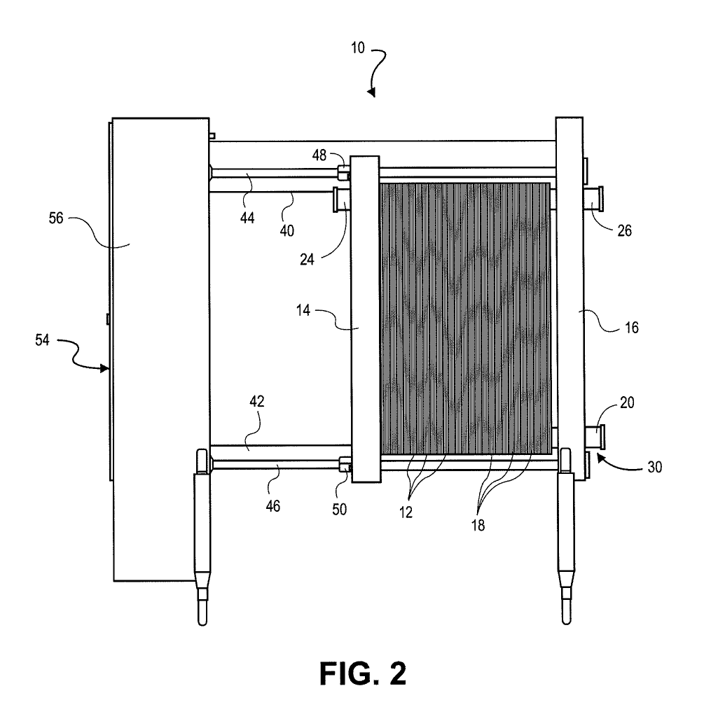

While the plate heat exchanger 10 shown in FIG. 1 is illustrated with one heat exchange plate 18 and two gaskets 12, the various embodiments of the invention are not limited in this manner, but rather, may include any suitable number of heat exchange plates 18 and gaskets 12. For example, as shown in FIG. 2, the plate heat exchanger 10 may include tens or hundreds of heat exchange plates 18 and gaskets 12. In order to retain the heat exchange plates 18 and gaskets 12 in alignment, the plate heat exchanger 10 may include upper and lower support beams 40 and 42.

To compress the gaskets 12 between the heat exchange plates 18, the plate heat exchanger 10 may include threaded tie bars 44 and 46 configured to respectively mate with a threaded nut 48 and 50. The threaded nuts 48 and 50 are captured with respect to the follower 14. A drive mechanism 54 is configured to rotate the threaded tie bars 44 and 46 and, via the translation of the threaded nuts 48 and 50 along the threaded tie bars 44 and 46, the follower 14 is urged towards the head 16. The drive mechanism 54 may be disposed within a housing 56. While the drive mechanism 54 may include any suitable device capable of urging the follower 14 towards the head 16, a particularly suitable drive mechanism is described in U.S. Pat. No. 6,899,163, titled Plate Heat Exchanger and Method for Using the Same, the disclosure of which is hereby incorporated by reference in its entirety.

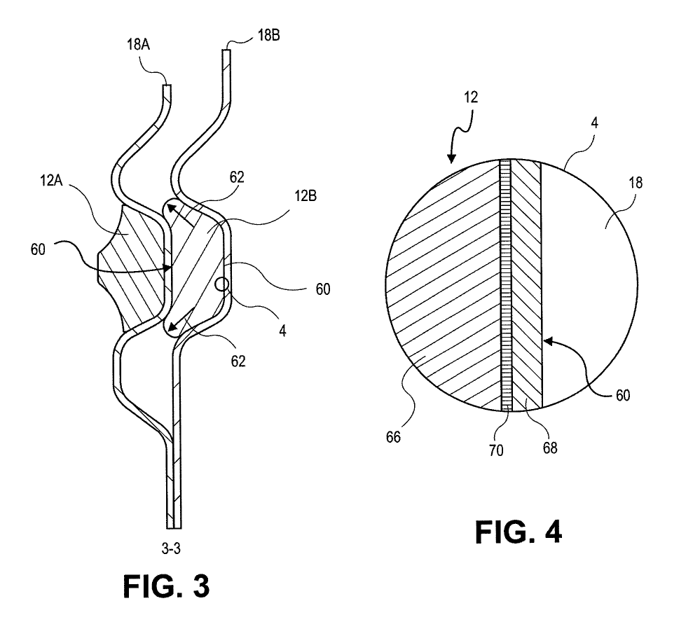

FIG. 3 is a cross sectional view 3-3 of a pair of the gaskets 12 (denoted as gasket 12A and 12B) disposed in an assembly of the heat exchange plates 18 (denoted as heat exchange plate 18A and 18B). Gasket 12A is disposed in an uncompressed state within a gasket channel of the heat exchange plate 18A and gasket 12B is shown in a compressed state disposed between heat exchange plate 18A and 18B. As shown in FIG. 3, the gasket 12B is compressed 18 with sufficient force to conform to any irregularities along the surface of the heat exchange plates 18A and 18B and form a seal along a gasket/plate interface 60. In order to form an essentially fluid-tight seal along the tens of meters or kilometers of the gasket/plate interface 60, the gasket 12B is subjected to sufficient compressive force to urge the gasket 12B to bulge outwardly as indicated by arrows 62. This bulging may adversely effect the structural integrity of a conventional gasket. For example, the bulging may cause an outer surface or coating to split or crack. In addition, the gasket may be subjected to shear stress causing de-lamination of the outer surface or coating from a core portion. It is an advantage of various embodiments of the invention that the gasket 12B is configured to withstand these detrimental forces and maintain structural integrity.

In various embodiments, the assembly of heat exchange plate 18A and 18B may be welded together or may be assembled individually. In this regard, for the purposes of this disclosure, the term, “heat exchange plate” includes a single heat exchange plate and an assembly of heat exchange plates. The assembly of heat exchange plates may include any suitable number of heat exchange plates in a pre-assembled unit. In various examples, these pre-assembled heat exchange plates may be welded or otherwise fastened together.

FIG. 4 is a magnified view of the cross sectional view 3-3. As shown in FIG. 4, the gasket 12 includes a core material 66, coating 68, and an interface layer 70. In accordance with an embodiment of the invention, the interface layer 70 is generated by permeation or grafting and irreversibly chemically binds the coating 68 to the core material 66. This grafting in particular generates a concentration gradient from the core material 66 to the coating 68. This concentration gradient disposed within and defining the interface layer 70 has a thickness that is relatively greater than that achieved conventionally and does not suffer from the disadvantages associated with adhesive layers. More particularly, the interface layer 70 is about 0.7 MIL to about 1.0 MIL thick (0.0178-0.0254 millimeters).

It is an advantage of embodiments of the invention that this interface layer 70 reduces the shear stress at the boundary between the core material 66 and the coating 68. For example, shear stress is generally represented by the formula τ=F/A where τ is the shear stress, F is the force applied, and A is the cross sectional area. In conventionally coated gaskets, the cross sectional area at the interface between the coating and the core material is relatively smaller than the interface layer 70, and thus, the shear stress experienced in conventionally coated gaskets is greater than experience by the gasket 12. In general, gaskets used in plate heat exchangers are subjected to these types of high shear stress at two points. The first, as stated above, occurs during compression of the gaskets. The second occurs during decompression. In this regard, plate heat exchangers are periodically disassembled to perform maintenance. During disassembly, the gaskets are decompressed. If the core material returns to its original shape more quickly than the coating, the interface between the core material and the coating may experience a high shear stress. Delamination in conventionally coated gaskets is further exacerbated relative to the gasket 12 at least because the bond strength between the base material and coating of conventionally coated gaskets is relatively weaker than the chemical bonding that is present in the gasket 12. In order to generate this chemical bonding, the surface of the core material 66 is prepared and the coating is cross linked to this prepared surface.

### Methods and Results

### Example 1

### Method of Coating an Ethylene Propylene Diene Monomer (EPDM) and Nitrile Butadiene Rubber (NBR) Gasket Core Material with a Fluorocarbon Coating

The fluoric content of the fluorocarbon coating mixture is approximately 71%. In general, the fluoric content may include any suitable fluorocarbon such as, for example, polytetrafluoroethylene (PTFE), Perfluoroalkoxy (PFA), Fluorinated ethylene propylene (FEP) is a copolymer of hexafluoropropylene and tetrafluoroethylene, polyethylenetetrafluoroethylene (ETFE), polyvinylfluoride (PVF), polyethylenechlorotrifluoroethylene (ECTFE), polyvinylidene fluoride (PVDF), polychlorotrifluoroethylene (PCTFE), Perfluoropolyether (PFPE), polymers of hexafluoropropylene (HFP), tetrafluoroethylene (TFE), and the like. In addition to the fluorocarbon, the fluorocarbon mixture includes:

1. Magnesium oxide
2. Nepheline syenite
3. tert-Butyl acetate is a solvent
4. Methyl isobutyl ketane (MIBK)
5. Carbon black

Magnesium oxide is optionally added. In general, compounds, such as metal oxides, accelerate curing and increase the cross-link density in the fluoroelastomer polymer by acting as acid acceptors. As such, magnesium oxide may be incorporated into the fluoroelastomer composition. Magnesium oxide or other such metal oxide may be incorporated into the composition in a proportion of from about 5% to about 30% by weight of the fluoroelastomer component. Preferred metal oxides for use in the compositions of this invention include magnesium oxide, zinc oxide, lead oxide, and calcium hydroxide. Nepheline syenite is a low solvent absorptive (LSA) filler to increase viscosity. Tert-Butyl acetate is a solvent. Methyl isobutyl ketane (MIBK) is a solvent. Carbon black is a filler to increase viscosity. The catalyst composition used to help with the crosslinking is as follows:

1. Ethyl alcohol
2. Methyl alcohol

### 3. Ketamine

The fluorocarbon coating mixture is applied to the core material in the following manner.

1. The EPDM gasket core was heated to 90° F. (32.2° C.) and cleaned with Isopropyl alcohol in ultra sonic bath.
2. The EPDM gasket core was dried at 100° F. (37.8° C.) for 5-7 minutes.
3. The EPDM gasket core was subjected to a temperature of 100° F. (37.8° C.) for 20 minutes.
4. The EPDM gasket core was placed in a fixture to suspend and provide access to all sides of the EPDM gasket core.
5. The EPDM gasket core was placed in a controlled environment where relative humidity and air flow and temperatures were in place before the application of fluorocarbon compound.
6. The EPDM gasket core was coated (sprayed) with an approximately 4 MIL (0.1016 millimeters) thick layer of the fluorocarbon mixture.
7. The thickness of the coating was measured.
8. The fluorocarbon mixture was cured to the EPDM gasket core for 20 minutes at 200-225° F. (93.3-107.2° C.).
9. The fluorocarbon mixture was cured again for an extended time of 10 hours at 150° F. (65.6° C.) to crosslink the fluorocarbon mixture to the EPDM gasket core.
10. Conduct abrasion test to quantify the bond strength.

### Results

The overall technical properties of the fluorocarbon compound is as follows:

1. Viscosity (cps): 2,000
2. Wt sold (%): 30
3. Density (lb/gal): 8.5
4. SP gravity (water=1): 1.02
5. Tensile strength (psi): 1000

### 6. Elongation (%): 250

Other experiments with extreme fluids such as dairy products with high animal fat were also encouraging. A plate heat exchanger was prepared and tested with steam at high temperature and dry. The result are described in tabular form herein. In general, the untreated gasket showed significant degradation from oxygen attack. However, the treated elastomer showed a surprisingly good result.

### Example 2

### Formula for Generating Fluorocarbon Coating for an EPDM and NBR Gasket Core Material and Method of Coating the EPDM Gasket Core Material

The fluorocarbon mixture includes:

| | |
|---|---|
| 1. Triethylamine | 0.350% |
| 2. Cadmium/Selenium sulfide | 3.45% |
| 3. Selenium sulfide | 1.5% |
| 4. Polytetrafluoroethylene | 3.75% |
| 5. Barium sulfate | 0.56% |
| 6. Isopropyl alcohol | 15.35% |
| 7. N-methyl pyrrolidone (NMP) is a dipolar aptotic solvent | 4.3% |
| 8. Deionized Water (remainder) | 70.74% |

Polytetrafluoroethylene was used as the fluorocarbon. N-methyl pyrrolidone (NMP) is a dipolar aprotic solvent. The fluorocarbon coating mixture is applied to the core material in the following manner.

### 1. Degrease

2. Alkaline was or Hot Sodium Hypochlorite solution wash
3. Plasma treatment
4. 1^{st} coating @250° F. (121° C.) for 10 minutes
5. Dry for 15-20 minutes and allow to cool to touch (about 40° C.)
6. 2^{nd} coating @250° F. (121° C.) for 10 minutes
7. 3^{rd} coating @350° F. (176.7° C.) for 10 minutes

### Results

The overall technical properties of the fluorocarbon compound is as follows:

1. Viscosity: 15-25 seconds with a signature series #2 Zahn cup @ 77° F. (25° C.)
2. Density (lb/gal): 9.4-9.8
3. SP gravity (water=1): 1.10
4. Volitile organic compound (VOC): 2.53 lb/gal
5. Percent solid: 28.5-32.5% by weight

### 6. Elongation (%): >100

### Example 3

### Formula for Generating Fluorocarbon Coating for an EPDM and NBR Gasket Core Material and Method of Coating the EPDM Gasket Core Material

The fluorocarbon mixture includes:

| | |
|---|---|
| 1. Gamma-butyrolactone (GBL) | 0.15-2.5% |
| 7. N-methyl pyrrolidone (NMP) | 17.37% |
| 3. Solvent Naptha (heavy) | 5.84% |
| 4. Napthalene | 2.12% |
| 5. Fluorinated ethylene propylene | 4.3% |
| 6. Color index international (C.I.) pigment blue 28 | 2.67% |
| 7. Deionized Water (remainder) | 67.55-65.2% |

Fluorinated ethylene propylene was used as the fluorocarbon. Gamma-butyrolactone (GBL) is a solvent. N-methyl pyrrolidone (NMP) is a dipolar aprotic solvent. The fluorocarbon coating mixture is applied to the core material in the following manner.

1. Plasma treatment
2. Removal of debris from substrate
3. Clean with MEK/Acetone
4. 1^{st} coating sprayed on substrate to a thickness of about 0.5 MIL (0.0127 millimeters)
5. Dry for 15-20 minutes @ 200-400° F. (93.3-204.4° C.)
6. Cool to touch (about 40° C.)
7. 2^{nd} coating sprayed on substrate to a thickness of about 0.5 MIL (0.0127 millimeters)
8. Dry for 15-20 minutes @ 200-400° F. (93.3-204.4° C.)
9. Flash off solvents @ 400° F. (204.4° C.) for 10 minutes
10. Cure @ 750° F. (399° C.) for 10 minutes

Coating thickness of about 0.8-1.0 MIL (0.0203-0.0254 millimeters) was applied to the core material.

### Results

The overall technical properties of the fluorocarbon compound is as follows:
1. Viscosity: 35-45 seconds with a signature series #3 Zahn cup @ 77° F. (25° C.)
2. Density (lb/gal): 9.5
4. Volitile organic compound (VOC): 6.90 lb/gal
5. Percent solid: 29.40% by weight
6. Flash point: 149° F. (65° C.)
6. Elongation (%): >100

TABLE 1
ASTM #3 TEST AT AMBIENT TEMP

| *** | TREATED | UNTREATED |
|---|---|---|
| EPDM GASKET SUBSTRATE | NO CHANGE | 15% SWELL |
| subjected to ASTM #3 | | |
| Nitric Acid @ 5% cmc. | NO CHANGE | 1% SWELL |
| High Butter Cream @ 40% fat | NO CHANGE | 1% SWELL |
| Hydrogen Peroxide solution @ | NO CHANGE | 1% SWELL |
| 30% cmc. | | |
| ASTM #1 (Aliphatic) | NO CHANGE | 4% SWELL |
| ASTM #3 (Aromatic) | NO CHANGE | 15% SWELL |

TABLE 2
BOND STRENGTH TEST

| | Fluorocarbon | Fluorocarbon | Fluorocarbon |
|---|---|---|---|
| | layer on EPDM | layer on EPDM | layer on NBR |
| | Peroxide | Resin | Peroxide |
| 1 | Pass | Pass | Pass |
| 2 | Pass | Pass | Pass |
| 3 | Pass | Pass | Pass |
| 4 | Pass | Pass | Pass |
| 5 | Pass | Pass | Pass |

Coated gasket was scratched and tape tested (adhesive tape applied and removed) to test for coating failure.

TABLE 3
TESTING IN HEATED, PRESSURIZED,
PLATE HEAT EXCHANGER

| | Temperature | Pressure psi, | |
|---|---|---|---|
| Day | (° C.) | (kgf/cm²) | Leak/No leak |
| 0 | 152 | 53 (3.73) | No leak |
| 1 | 153 | 50 (3.52) | No leak |
| 2 | 150 | 50 (3.52) | No leak |
| 3 | 154 | 52 (3.66) | No leak |
| 4 | 152 | 53 (3.73) | No leak |
| 5 | 156 | 53 (3.73) | No leak |
| 6 | 150 | 52 (3.66) | No leak |
| 7 | 154 | 50 (3.52) | No leak |
| 8 | 150 | 53 (3.73) | No leak |
| 9 | 158 | 52 (3.66) | No leak |
| 10 | 156 | 52 (3.66) | No leak |
| 11 | 152 | 53 (3.73) | No leak |
| 12 | 158 | 52 (3.66) | No leak |
| 13 | 160 | 52 (3.66) | No leak |

TABLE 4
GASKET SAMPLES (5 OF EACH) WERE INSTALLED
IN A HEATED, PRESSURIZED, PLATE HEAT EXCHANGER
AND SUBJECTED TO 150-160° C. FOR 13 DAYS AND
HARDNESS TESTED (HARDNESS IN INTERNATIONAL
HARDNESS “IRHD” SCALE)

| | Sample | | | |
|---|---|---|---|---|
| | material | Description | Hardness | Comments |
| 1 | EPDM | Untreated | 75, 77, 78, 79, 79 | Somewhat |
| | (Peroxide) | | | stiff/hard |
| 2 | EPDM (Resin) | Untreated | 78, 77, 79, 77, 78 | Okay |
| 3 | EPDM | Treated with | 76.5, 77, 78, 77, 77.5 | Flexible and |
| | (Peroxide) | EX1 | | smooth |
| 4 | EPDM (Resin) | Treated with | 77, 76.5, 79, 76.5, 76 | not stiff- |
| | | EX1 | | flexible |
| 5 | NBR | Untreated | 79.5, 79, 78.5, 80 | Slightly |
| | (Peroxide) | | | stiff/hard |
| 6 | NBR | Treated with | 77, 77.5, 79, 78, 77 | Smooth and |
| | (Peroxide) | EX1 | | flexible |
| 7 | EPDM | PTFE coated | 79, 79.5, 79, 78.5 | Coating |
| | (Peroxide) | | | peeled |
| 8 | EPDM (Resin) | PTFE coated | 79, 78.5, 80, 79, 78.5 | Coating |
| | | | | peeled |

As shown in the Tables 1 to 4 above, the gaskets coated in accordance to embodiments of the invention exhibited markedly improved performance in comparison to both untreated gaskets and conventionally PTFE coated gaskets.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A plate heat exchanger comprising:
a set of plates;
a set of gaskets, each one of the set gaskets being disposed between two adjacent plates of the set of plates, a gasket of the set of gaskets comprising:
a base material;
a fluorocarbon coating disposed on the base material; and
an interface layer disposed between the base material and the fluorocarbon coating, the interface layer comprising a material gradient transitioning from the base material to the fluorocarbon coating, wherein the fluorocarbon coating is chemically bound to the base material.

2. The plate heat exchanger according to claim 1, wherein the fluorocarbon coating is about 4 MIL (0.1 mm) thick.

3. The plate heat exchanger according to claim 1, wherein the fluorocarbon coating is about 60% to about 75% fluoric content by weight

4. The plate heat exchanger according to claim 1, wherein the fluorocarbon coating comprises:
a fluoropolymer;
a magnesium oxide;
a nepheline syenite;
a tert-butyl acetate;
a methyl isobutyl ketane (MIBK); and
a carbon black.

5. The plate heat exchanger according to claim 4, wherein the fluorocarbon coating further comprises:
an ethyl alcohol;
a methyl alcohol; and
a ketamine.

6. The plate heat exchanger according to claim 1, wherein the base material includes ethylene propylene diene Monomer (EPDM) peroxide rubber.

7. The plate heat exchanger according to claim 1, wherein the base material includes ethylene propylene diene Monomer (EPDM) resin rubber.

8. The plate heat exchanger according to claim 1, wherein the base material includes nitrile butadiene rubber (NBR).

9. The plate heat exchanger according to claim 1, wherein the fluorocarbon coating comprises:
a triethylamine;
a cadmium/selenium sulfide;
a selenium sulfide;
a polytetrafluoroethylene;
a barium sulfate;
an isopropyl alcohol; and
a N-methyl pyrrolidone (NMP).

10. The plate heat exchanger according to claim 1, wherein the fluorocarbon coating comprises:
a gamma-butyrolactone (GBL) is a solvent;
a N-methyl pyrrolidone (NMP) is a dipolar aprotic solvent;
a solvent Naptha;
a napthalene;
a fluorinated ethylene propylene; and
a color index international (C.I.) pigment blue 28.

11. A method of manufacturing a gasket for a plate heat exchanger, the method comprising the steps of:
cleaning a gasket core, the gasket core comprising a base material;
heating the gasket core;
coating the gasket core with a liquid hydrocarbon mixture, the liquid hydrocarbon mixture permeating an outer surface of the gasket core and generating an interface layer disposed between the base material and the liquid hydrocarbon mixture, the interface layer comprising a material gradient transitioning from the base material to the liquid hydrocarbon mixture;
curing the liquid hydrocarbon mixture into an elastomeric coating, wherein the elastomeric coating is chemically bound to the base material.

12. The method according to claim 11, further comprising:
cleaning the gasket core with Isopropyl alcohol in ultra sonic bath.

13. The method according to claim 12, further comprising:
pre-heating the gasket core to 90° F. (32.2° C.).

14. The method according to claim 11, further comprising:
pre-heating the gasket core to 100° F. (37.8° C.) for 20 minutes.

15. The method according to claim 11, further comprising:
spraying the liquid hydrocarbon mixture to a thickness of about 4 MIL (0.1 m) on the gasket core.

16. The method according to claim 11, further comprising:
curing the liquid hydrocarbon mixture into an elastomeric coating for 20 minutes at 200-225° F. (93.3-107.2° C.).

17. The method according to claim 16, further comprising:
curing the elastomeric coating for 10 hours at 150° F. (65.6° C.).

18. The method according to claim 11, further comprising spraying the liquid hydrocarbon mixture having about 60% to about 75% fluoric content by weight

19. The method according to claim 11, further comprising
preparing the liquid hydrocarbon mixture, the liquid hydrocarbon mixture comprising:
a fluoropolymer;
a magnesium oxide;
a nepheline syenite;
a tert-butyl acetate;
a methyl isobutyl ketane (MIBK); and
a carbon black.

20. The method according to claim 19, wherein the liquid hydrocarbon mixture further comprises:
an ethyl alcohol;
a methyl alcohol; and
a ketamine.
